(19) United States
(12) Patent Application Publication
(10) Pub. No.: US 2008/0252861 A1
(43) Pub. Date: Oct. 16, 2008

(54) Rear projection type display apparatus

(75) Inventors: Eiji Niikura, Tokyo (JP); Atsushi Michimori, Tokyo (JP); Norichika Sugano, Tokyo (JP); Tomomi Matsui, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 12/081,079

(22) Filed: Apr. 10, 2008

(30) Foreign Application Priority Data
Apr. 12, 2007 (JP) 2007-104691

(51) Int. Cl. G03B 21/28

(52) U.S. Cl. 353/77

(57) ABSTRACT

A rear projection type display apparatus includes a base in which an optical unit and an electrical circuit are accommodated and which has an opening at a rear side thereof, and a cabinet which supports a mirror and a screen and which is mounted to an upper side of the base. The base has a first connecting portion provided along at least one side of the opening, and the cabinet has a second connecting portion which engages the first connecting portion of the base along at least one side of the opening. One of the first connecting portion and the second connecting portion has a cross sectional shape which includes two facing inner walls and which is opened in one direction.

### BACKGROUND OF THE INVENTION

This invention relates to a rear projection type display apparatus, and particularly relates to a mounting structure of a base (in which an optical unit and an electrical circuit are accommodated) and a cabinet that holds a mirror and a screen.

The rear projection type display apparatus generally includes a cabinet for holding a mirror or a screen, and a box-shaped base in which an optical unit and an electrical circuit are accommodated. The cabinet is mounted to the upper side of the base.

The mounting structure of the cabinet and the base is as follows. The cabinet has through-holes for inserting screws formed at a bottom panel and at a lower end of a rear panel. The base has bosses formed at an upper panel (an inclined panel) and at an upper end of a rear panel so that the bosses face the through-holes. The screws are inserted through the through-holes from the front side of the cabinet, and brought into engagement with internal threads formed on the bosses, so that the cabinet and the base are integrated with each other (see for example, Patent Document 1).

Patent Document 1: Japanese Laid-Open Patent Publication No. 2004-294781 (FIGS. 7 and 8)

However, the structure in which the cabinet and the base integrated using the screws has a low rigidity at portions where the cabinet and the base are jointed by the screws. Therefore, when an external force (a torsion or the like) is applied to the rear projection type display apparatus, the cabinet and the base are displaced relative to each other due to a slip or the like at the portions where the cabinet and the base are jointed using the screws. Such a relative displacement may remain even after the external force is removed. As a result, when the rear projection type display apparatus is used, there is a problem that an image projected onto the screen by the optical unit may be deflected, and the image quality may be degraded.

Further, in order to enhance the rigidity of a housing constituted by the base and the cabinet, it is necessary to strongly fix the cabinet and the base with each other using a multiple of screws. As a result, there is a problem that the number of assembling processes may increase due to tightening operations of the screws, so that the manufacturing cost may increase.

### SUMMARY OF THE INVENTION

The present invention is intended to solve the above described problems, and an object of the present invention is to construct a housing with high rigidity by combining a cabinet and a base to exclude an effect of an external force on the housing, to thereby provide a rear projection type display apparatus which has an enhanced image quality, which can be easily assembled, and which is low in cost.

The present invention provides a rear projection type display apparatus including a base in which an optical unit and an electrical circuit are accommodated and which has an opening at a rear side thereof, and a cabinet which supports a mirror and a screen and which is mounted to an upper side of the base. The base has a first connecting portion provided along at least one side of the opening, and the cabinet has a second connecting portion which engages the first connecting portion of the base along at least one side of the opening. One of the first connecting portion and the second connecting portion has a cross sectional shape which includes two facing inner walls and which is opened in one direction.

Since the first connecting portion of the base and second connecting portion the cabinet engage each other along at least one side of the opening, the cabinet and the base can be stiffly fixed to each other in a large area, so that the rigidity of the housing can be enhanced. Therefore, even when an external force is applied to the housing during a carrying operation, an installing operation or the like, the displacement of the cabinet with respect to the base can be restricted, with the result that the image quality can be enhanced. Further, the cabinet and the base are fixed to each other by the engagement between the first and second connecting portions, and therefore the number of screws can be reduced. Consequently, the assembling operation of the rear projection type display apparatus can be simplified, and the manufacturing cost can be reduced.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

In the attached drawings:

FIG. 1 is a perspective view showing a rear projection type display apparatus according to the embodiment of the present invention;

FIG. 2 is an exploded perspective view showing the rear projection type display apparatus according to the embodiment of the present invention;

FIG. 3 is a sectional view taken along line III-III shown in FIG. 1;

FIG. 4A is an enlarged view of a part indicated by a reference mark IV shown in FIG. 3;

FIG. 4B is an enlarged view of an engaging portion of first and second connecting portions in the part shown in FIG. 4A;

FIG. 5 is a sectional view taken long line V-V shown in FIG. 1;

FIG. 6A is an enlarged sectional view showing a part indicated by a reference mark VI shown in FIG. 5, and

FIG. 6B is an enlarged sectional view showing an engaging portion of first and second connecting portions in the part shown in FIG. 6A.

### DETAILED DESCRIPTION OF THE PREFERRED EMBODIMENT

Embodiments of the present invention will be described with reference to the attached drawings.

### Embodiment 1

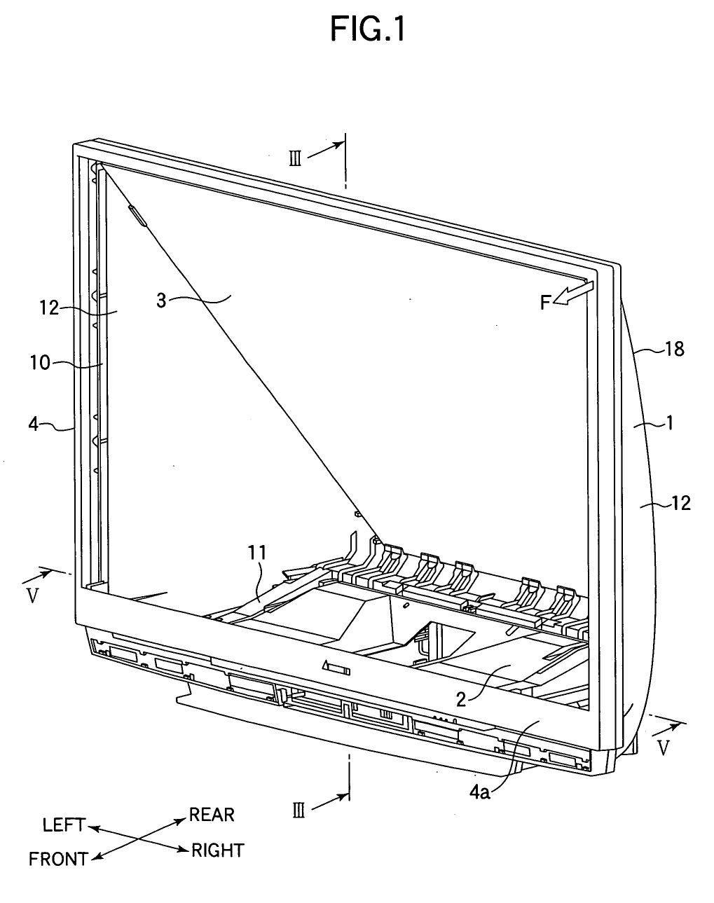

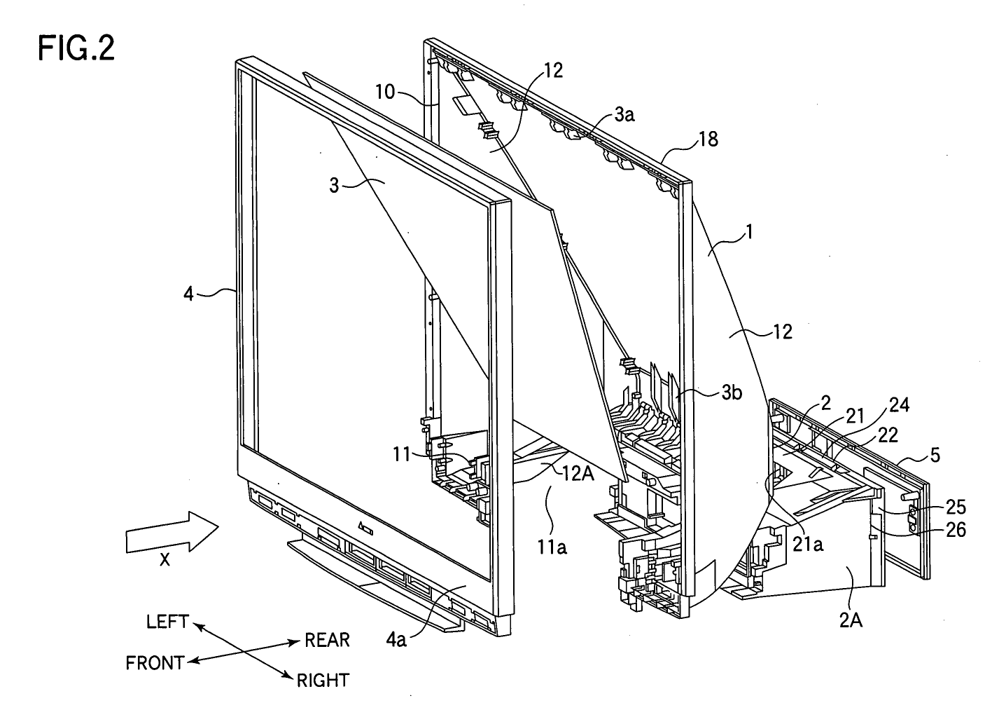

FIG. 1 and FIG. 2 are a perspective view and an exploded perspective view of a rear projection type display apparatus according to Embodiment 1 of the present invention. As shown in FIG. 1, the rear projection type display apparatus includes a cabinet 1 and a base 2 both of which are composed of resin molded articles.

The cabinet 1 includes a front frame 10 having a rectangular opening, and a left/right pair of side walls 12 (both of which are referred to by the same reference numeral) provided on both sides of the front frame 10, an inclined wall 18 provided on the rear side of the front frame 10 and the side walls 12, and a bottom face portion 11 located at the bottom the front frame 10, side walls 12 and the inclined wall 18.

A bezel 4 for holding a rectangular screen (not shown) is mounted to the front frame 10 of the cabinet 1. A mirror 3 is mounted at a predetermined angle inside the inclined wall 18 of the cabinet 1. The mirror 3 is supported by a plurality of claws 3a (FIG. 2) provided on the upper end of the front frame 10 of the cabinet 1 and by a plurality of claws 3b (FIG. 2) provided on the bottom face portion 11 of the cabinet 1.

As shown in FIG. 2, the bottom face portion 11 of the cabinet 1 has an inclination which is inclined so that the height increases from the front to the rear. A rectangular opening 11a is formed on the center of the bottom face portion 11. The opening 11a is slightly smaller than an upper face portion 21 (described later) of the base 2, and has substantially the same shape as the upper face portion 21 of the base 2.

In this regard, the screen side (i.e., the bezel 4 side) of the rear projection type display apparatus is referred to as a front side, and the opposite side is refereed to as a rear side. Further, right and left sides are respectively defined as indicated by arrows in FIG. 1, i.e., from the point of view of an observer observing the screen from the front.

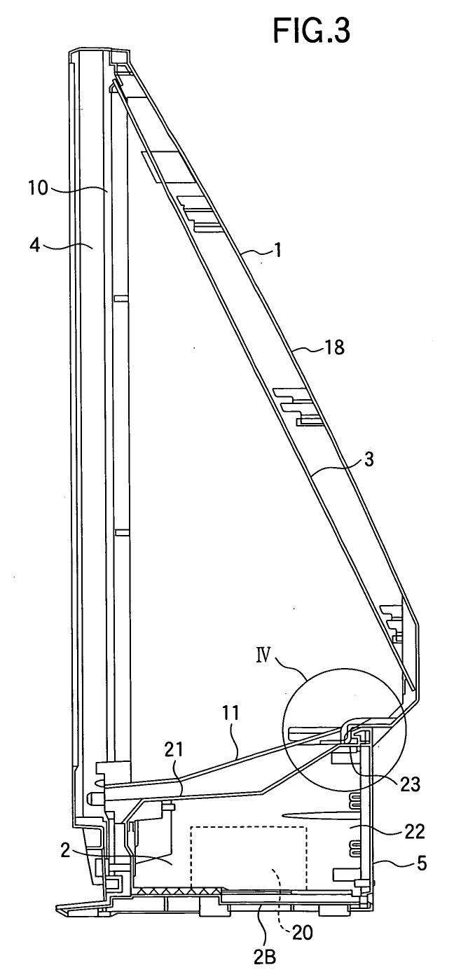

The base 2 is substantially box-shaped, and has an upper face portion 21, a left/right pair of lateral face portions 2A (both of which are referred to by the same reference numeral) and a bottom face portion 2B (FIG. 3). One of the lateral face portions 2A on the left side is hidden in FIG. 2. The rear side of the base 2 is opened, where a rectangular rear-side opening 22 is formed. An optical unit 20 and an electrical circuit are accommodated inside the base 2. The optical unit 20 includes a light source that emits a light, a light modulating element that modulates the emitted light according to image information to form an image light, and a projection optical system that projects the image light, or the like. The electrical circuit drives and supplies electric power to the light source and the optical modulating element.

The upper face portion 21 of the base 2 has an inclination such that the height increases from the front to the rear. A rectangular opening 21a is formed on the center of the upper face portion 21, and the opening 21a has a required minimum size so as not to interfere with a light from the optical unit 20 to the mirror 3. The rear-side opening 22 of the base 2 is closed by a back cover 5 which is substantially in the form of a plate.

The cabinet 1 and the base 2 are integrated with each other by sliding the bottom face portion 11 of the cabinet 1 along the upper face portion 21 (on both sides of the opening 21a in the left-right direction) of the base 2 in the direction shown by an arrow X in FIG. 2 as described later.

The bezel 4 is a rectangular frame member to which the screen is mounted via not shown mounting members. The bezel 4 to which the screen is mounted is fixed to the front frame 10 of the cabinet 1 from the front side. A lower portion 4a of the bezel 4 in a predetermined area from the lower end of the bezel 4 constitutes a decorating plate that covers the front side of the base 2.

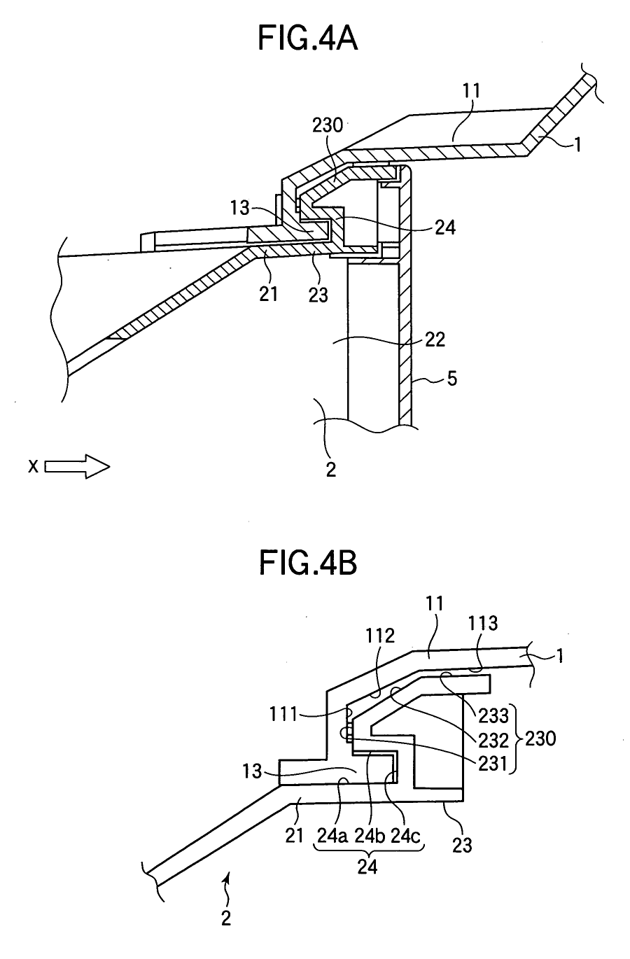

Next, a mounting structure of the cabinet 1 and the base 2 will be described. FIG. 3 is a sectional view taken along a line III-III in FIG. 1 showing the rear projection type display apparatus according to this embodiment. FIG. 4A is an enlarged sectional view showing a part indicated by a reference mark IV in FIG. 3.

As shown in FIG. 4A, a first connecting portion 24 is provided on the rear end of the upper face portion 21 of the base 2 so as to extend in the left-right direction along an upper side 23 of the rear-side opening 22. The first connecting portion 24 has a cross sectional shape of substantially rectangular C-shape. In other words, the first connecting portion 24 has a cross sectional shape including two facing inner walls (substantially parallel to each other) and is opened in one direction (to be more specific, toward the front) . In this example, the first connecting portion 24 takes the form of a groove.

A second connecting portion 13 is formed on the bottom face portion 11 of the base 11, which engages the first connecting portion 24. The second connecting portion 24 extends in the left-right direction, and has a rectangular cross sectional shape such that the second connecting portion 13 engages inside the first connecting portion 24.

The first connecting portion 24 of the base 2 and the second connecting portion 13 of the cabinet 1 engage each other on an area along the upper side 23 of the rear-side opening 22. In this regard, the first and second connecting portions 24 and 13 do not necessarily engage each other throughout the entire length of the upper side 23 of the rear-side opening 22, but need only engage each other for a certain length along the upper side 23 of the rear-side opening 22.

As constructed above, when the cabinet 1 is mounted to the base 2 by sliding the cabinet 1 with respect to the base 2 in the direction shown by the arrow X (i.e., from the front to the rear), the second connecting portion 13 of the cabinet 1 linearly engages the first connecting portion 24 of the base 2 along the upper side 23 of the rear-side opening 22, and therefore a structure in which the cabinet 1 and the base 2 are integrated with each other with high rigidity can be obtained.

In this regard, a predetermined gap is formed between the first and second connecting portions 24 and 13, which is determined in consideration of manufacturing errors in shapes and dimensions of respective connecting portions that may occur in a molding process of the connecting portions.

FIG. 4B is an enlarged view of an engaging portion of the first connecting portion 24 and the second connecting portion 13. The first connecting portion 24 has an inner surface 24a (i.e., an inner wall) which is on the same plane as the upper face portion 21 of the base 2, and another inner surface 24b (i.e., an inner wall) provided above the inner surface 24a so as to face the inner surface 24a, and an inner surface 24c provided so as to connect rear ends of the inner surfaces 24a and 24b. The inner surfaces 24b and 24c are formed on a projecting portion 230 formed on a rear end of the upper face portion 21 of the base 2.

The projecting portion 230 of the base 2 has a front end surface 231 extending upward from the front end of the inner surface 24b of the first connecting portion 24, an inclined surface 232 extending obliquely upward and rearward from the front end surface 231, and an upper surface 233 extending rearward from the upper end of the inclined surface 232. A vertical end surface 111, an inclined surface 112 and a horizontal surface 113 are formed on the bottom face portion 11 of the cabinet 1 respectively along the front end surface 231, the inclined surface 232 and the upper surface 233. When the first connecting portion 24 and the second connecting portion 13 engage each other, a part of the projecting portion 230 (i.e., from the front end surface 231 to the upper surface 233) is accommodated in a recess formed between the second connecting portion 13 and the horizontal surface 113 of the cabinet 1.

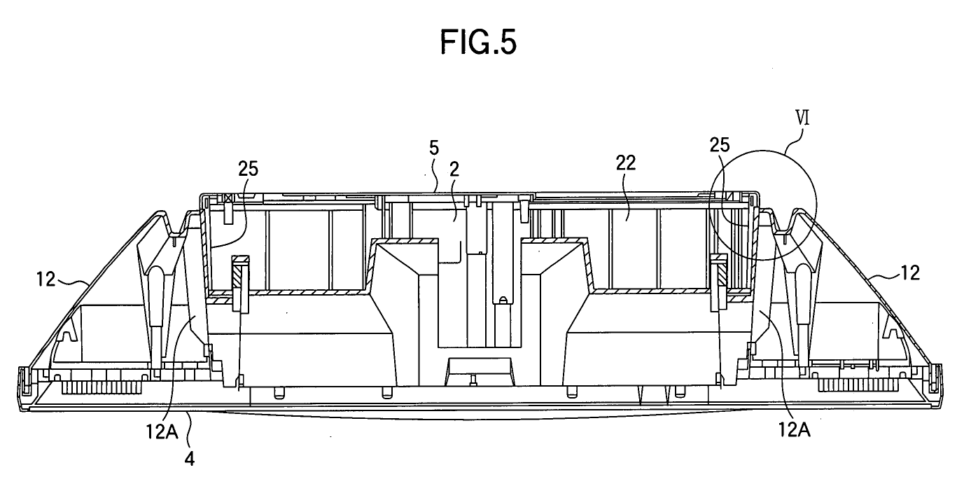

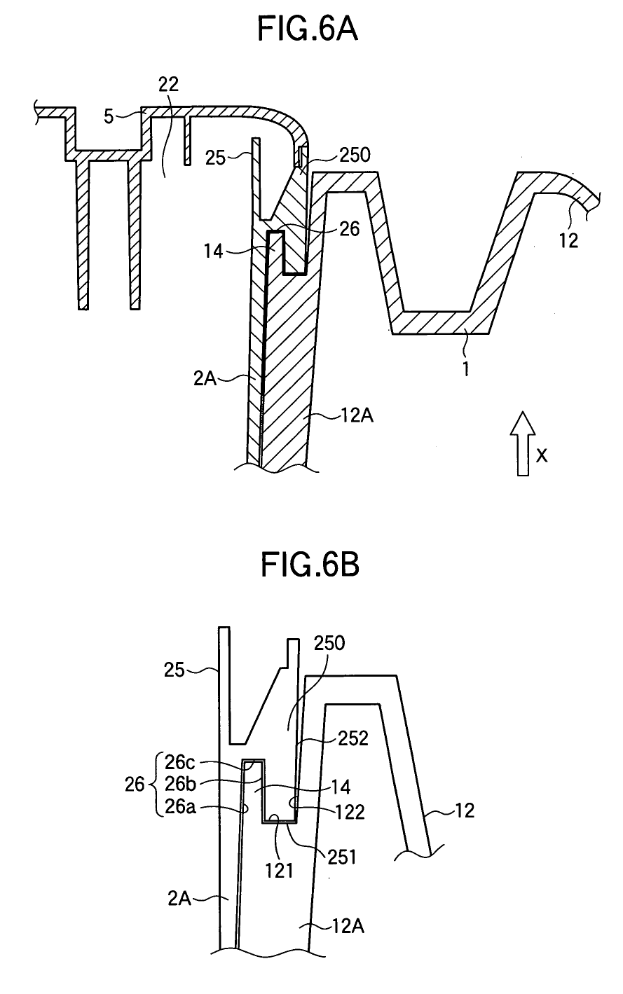

FIG. 5 is a sectional view of the rear projection type display apparatus of this embodiment, taken long line V-V shown in FIG. 1. FIG. 6A is an enlarged sectional view of a part indicated by a reference mark VI in FIG. 5.

As shown in FIG. 6A, a first connecting portion 26 is formed on-a right lateral face portion 2A of the base 2 and extends in the vertical direction along the right side 25 of the rear-side opening 22. The first connecting portion 26 has a cross sectional shape of substantially rectangular C-shape. To be more specific, the first connecting portion 26 has a cross sectional shape including two facing inner walls (substantially parallel to each other) and which is opened toward the front. In this example, the first connecting portion 26 takes the form of a groove.

The cabinet 1 has a right internal wall 12A provided on the inner side of the right side wall 12 so as to face the right lateral face portion 2A of the base 2. A second connecting portion 14 is formed on the inner wall 12A, which engages the first connecting portion 26 of the base 2. The second connecting portion 14 extends in the vertical direction, and has a rectangular cross sectional shape such that the second connecting portion 14 engages inside the first connecting portion 24.

The first connecting portion 26 of the base 2 and the second connecting portion 14 of the cabinet 1 engage each other along the right side 25 of the rear-side opening 22. In this regard, the first and second connecting portions 26 and 14 do not engage each other throughout the entire length of the right side 25 of the rear-side opening 22, but need only engage each other for a certain length along the right side 25.

As constructed above, when the cabinet 1 is mounted to the base 2 by sliding the cabinet 1 with respect to the base 2 in the direction shown by the arrow X (i.e., from the front to the rear), the second connecting portion 14 of the cabinet 1 linearly engages the first connecting portion 26 of the base 2 along the right side 25 of the rear-side opening 22, and therefore a structure in which the cabinet 1 and the base 2 are integrated with each other with high rigidity can be obtained.

In this regard, a predetermined gap is formed between the first and second connecting portions 26 and 14, which is determined in consideration of manufacturing errors in shapes and dimensions of respective connecting portions that may occur during the molding process of the connecting portions.

FIG. 6B is an enlarged sectional view showing an engaging portion of the first connecting portion 26 and the second connecting portion 14. As shown in FIG. 6B, the first connecting portion 26 has an inner surface 26a (i.e., an inner wall) which is on the same plane as the right lateral face portion 2A, another inner surface 26b (i.e., an inner wall) provided on the right side of the inner surface 26a so as to face the inner surface 26a, and an inner surface 26c provided so as to connect the rear ends of the inner surfaces 26a and 26b. The inner surfaces 26b and 26c are formed on a projecting portion 250 formed to project in the right direction from the rear end of the right lateral face portion 2A of the base 2.

Although not shown in FIG. 6B, another first connecting portion 26 is provided on the left lateral face portion 2A of the base 2, and both first connecting portions 26 (on both lateral face portions 2A) have left-right symmetric structures. Similarly, another second connecting portion 14 is provided on the left lateral face portion 2A of the base 2, and both second connecting portions 14 (on both lateral face portions 2A) have left-right symmetric structures. Therefore, when the cabinet 1 is mounted to the base 2 by sliding the cabinet 1 with respect to the base 2 in the direction shown by the arrow X, two second connecting portions 14 of the cabinet 1 linearly engage two first connecting portions 26 of the base 2 along the left and right sides 25 of the rear-side opening 22. Accordingly, a structure in which the cabinet 1 and the base 2 are integrated with each other with high rigidity can be obtained.

The cabinet 1 is mounted to the base 2 by being slid in the direction indicated by the arrow X in FIG. 1, and therefore it is necessary to fix the cabinet 1 with respect to the base 2 at a predetermined position in the front-rear direction. In this example, a plurality of screw fixing portions (not shown) are provided at predetermined intervals in the vicinities of the first connecting portions 24 and 26 of the base 2, and the base 2 is fixed to the cabinet 1 using the screw fixing portions.

For example, when the rear projection type display apparatus is applied with an external force (a torsion) F pulling the upper right end of the bezel 4 (FIG. 1) to the front, an upward force is applied to the right rear part of the cabinet 1 (i.e., the right part of the inclined wall 18 and the right side wall 12). Since the cabinet 1 and the base 2 are integrated with each other, the external force applied to the cabinet 1 is transmitted to the base 2, and therefore the upward force is also applied to the base 2.

In this case, according to this embodiment, the first connecting portions 24 and 26 of the base 2 and the second connecting portions 13 and 14 of the housing 1 respectively linearly engage each other, and therefore the external force can be linearly dispersed, and it becomes possible to oppose the external force with the rigidities of the cabinet 1 and the base 2. In other words, the housing constructed by the cabinet 1 and the base 2 has a structure which is hardly affected by the external force.

As described above, according to this embodiment, the first connecting portions 24 and 26 of the base 2 and the second connecting portions 13 and 14 of the housing 1 respectively linearly engage each other, and therefore the housing constructed by the cabinet 1 and the base 2 is hardly deformed even when the external force is applied during a carrying operation, an installing operation or the like. As a result, it becomes possible to restrict the deflection of the image when the rear projection type display apparatus is used, and the image quality can be enhanced.

Further, the first connecting portions 24 and 26 and the second connecting portions 13 and 14 respectively engage each other, and therefore the number of fixing screws can be reduced. As a result, it becomes possible to obtain a rear projection type display apparatus which is low in cost and which can be simply assembled, compared with a conventional rear projection type display apparatus.

Furthermore, the first connecting portions 24 and 26 are formed on the projecting portions 230 and 250 provided on the upper face portion 21 and lateral face portions 2A of the base 2, and therefore it becomes possible to provide the first connecting portions 24 and 26 on positions where the first connecting portions 24 and 26 engage the second connecting portions 13 and 14 when the cabinet 1 is slid on the base 2. Therefore, the mounting operation of the cabinet 1 to the base 2 becomes easy.

In the above description, the first connecting portion 24 of the base 2 and the second connecting portion 13 of the cabinet 1 engage each other along the upper side 23 of the rear-side opening 22, and the first connecting portions 26 of the base 2 and the second connecting portions 14 of the cabinet 1 engage each other along the left and right sides 25 of the rear-side opening 22. However, it is also employ an arrangement in which only the first connecting portion 24 of the base 2 engages the second connecting portion 13 of the cabinet 1, or an arrangement in which only one of the first connecting portions 26 of the base 2 engage corresponding one of the second connecting portions 14 of the cabinet 1. In either case, there is a certain advantage in combining the cabinet 1 and the base 2 to obtain a housing with high rigidity.

Further, in the above description, the first connecting portions 24 and 26 of the base 2 have the cross sectional shapes of rectangular C-shape and the second connecting portions 13 and 14 have the shapes so as to engage the first connecting portions 24 and 26. However, it is also possible that the second connecting portions 13 and 14 of the cabinet 1 have the cross sectional shapes of rectangular C-shape and the first connecting portions 24 and 26 have shapes so as to engage the second connecting portions 13 and 14.

Further, the cross sectional shape of each of the first connecting portions 24 and 26 is not limited to a rectangular C-shape, but can be any shape (for example, U-shape or the like) which is opened in one direction (in particular, parallel to a direction in which the cabinet 1 is mounted to the base 2) and with which the cabinet 1 and the base 2 can be surely connected to each other.

The present invention is applicable to the rear projection type display apparatus (for example, a projection television) that reflects a projected image from an optical unit using a mirror, and projects the image onto the screen from the rear side.

While the preferred embodiments of the present invention have been illustrated in detail, it should be apparent that modifications and improvements may be made to the invention without departing from the spirit and scope of the invention as described in the following claims.

What is claimed is:

1. A rear projection type display apparatus comprising:
a base in which an optical unit and an electrical circuit are accommodated, said base having an opening at a rear side thereof, and
a cabinet which supports a mirror and a screen, said cabinet being mounted to an upper side of said base,
wherein said base has a first connecting portion provided along at least one side of said opening, and said cabinet has a second connecting portion which engages said first connecting portion of said base along said at least one side of said opening, and
wherein one of said first connecting portion and said second connecting portion has a cross sectional shape which includes two facing inner walls and which is opened in one direction.

2. The rear projection type display apparatus according to claim 1, wherein said first connecting portion has a cross sectional shape which is opened toward the front, and
wherein said second connecting portion engages said first connecting portion from the front.

3. The rear projection type display apparatus according to claim 1, wherein said first connecting portion is provided along an upper side of said opening, and
wherein said second connecting portion engages said first connecting portion along said upper side of said opening.

4. The rear projection type display apparatus according to claim 1, wherein said first connecting portion is provided along at least one lateral side of said opening, and
wherein said second connecting portion engages said first connecting portion along said at least one lateral side of said opening.

5. The rear projection type display apparatus according to claim 1, wherein a plurality of said first connecting portions are provided along an upper side and at least one lateral side of said opening, and
wherein a plurality of said second connecting portions engage said first connecting portions along said upper side and said at least one lateral side of said opening.

6. The rear projection type display apparatus according to claim 3, wherein said first connecting portion is formed on a projecting portion formed on an upper surface of said base.

7. The rear projection type display apparatus according to claim 4, wherein said first connecting portion is formed on a projecting portion formed on a lateral surface of said base.
